(19) United States
(12) Patent Application Publication
(10) Pub. No.: US 2024/0270875 A1
(43) Pub. Date: Aug. 15, 2024

(54) A PROCESS FOR PRODUCING A METHYLCELLULOSE OR HYDROXYALKYL METHYLCELLULOSE

(71) Applicant: NUTRITION & BIOSCIENCES USA 1, LLC, Rochester, NY (US)

(72) Inventors: MATTHIAS KNARR, BOMLITZ (DE); OLIVER PETERMANN, BOMLITZ (DE)

(21) Appl. No.: 18/568,436

(22) PCT Filed: Jun. 3, 2022
(86) PCT No.: PCT/EP2022/065168

§ 371 Date: Dec. 8, 2023

(30) Foreign Application Priority Data
Jun. 8, 2021 (EP) 21178171.1

(51) Int. Cl. C08B 11/08

(52) U.S. Cl. CPC C08B 11/08

(57) ABSTRACT

Methylcellulose or hydroxyalkyl methylcellulose is efficiently produced in a process that comprises the steps of a) contacting cellulose with an aqueous alkali hydroxide to produce alkali cellulose; b) reacting the alkali cellulose produced in step a) with a methylating agent in the presence or absence of a hydroxyalkylating agent to obtain a first reaction mixture; c) contacting the first reaction mixture obtained in step b) with solid alkali hydroxide having a water content of not more than 20 wt. %, based on dried alkali hydroxide, with or without contacting a second amount of a methylating agent with the first reaction mixture, to obtain a second reaction mixture; and d) isolating the produced methylcellulose or hydroxyalkyl methylcellulose from the second reaction mixture.

### FIELD

The present invention relates to a process of increased efficiency for producing methylcelluloses or hydroxyalkyl methylcelluloses.

### INTRODUCTION

Methylcelluloses and hydroxypropyl methylcelluloses have “thermoreversible gelation properties”. Described specifically, when an aqueous solution of methylcellulose or hydroxypropyl methylcellulose is heated, de-hydration of the hydrophobic methoxyl groups localized in the polymeric molecules occurs and it turns into a hydrous gel, with embedded water molecules. When the resulting hydrous gel is cooled, on the other hand, the hydrophobic methoxyl groups in the polymeric molecules are re-hydrated, whereby the gel returns to the original viscous solution.

Methylcelluloses are polymers that have anhydroglucose units joined by 1-4 linkages. Each anhydroglucose unit contains hydroxyl groups at the 2, 3, and 6 positions. Partial or complete substitution of these hydroxyl groups creates cellulose derivatives. For example, treatment of cellulosic fibers with caustic solution, followed by a methylating agent, yields cellulose ethers substituted with one or more methoxy groups. If not further substituted with other groups, this cellulose derivative is known as methylcellulose. An essential property of methylcelluloses is the degree of the methyl substitution, DS(methyl), in the art also designated as degree of the methoxyl substitution, DS(methoxyl), which is the average number of OH groups substituted with methoxyl groups per anhydroglucose unit. A high DS(methoxyl) is very desirable as it provides, among others, good water solubility and high gel strength to the methylcellulose. A high gel strength or elastic modulus is a physical property that is important in some food compositions or pharmaceutical applications. This property relates to the strength with which a methylcellulose binds or holds food particles together.

Thus, methylcelluloses have been widely employed as additives to food compositions and processes to provide physical properties such as thickening, freeze/thaw stability, lubricity, moisture retention and release, film formation, texture, consistency, shape retention, emulsification, binding, suspension, and gelation. Methylcelluloses are also useful in other applications such as building products, industrial products, agricultural products, personal care products, household products, and pharmaceutical products. Useful pharmaceutical applications include capsules, encapsulants, tablet coatings, and excipients for medicaments and drugs.

U.S. Pat. No. 6,235,893 discloses how to make methylcelluloses which have elevated gel strength for a given molecular weight or viscosity grade. Enhanced gel strength is achieved by producing methylcellulose in two stages wherein a) in a first stage cellulose pulp is contacted with a first amount of aqueous sodium hydroxide to alkalize it to a first level of alkalization and subsequently with a first amount of a methylating agent to form cellulose ether having a first level of methoxy substitution; and in a second stage b) contacting the cellulose ether of first level of methoxy substitution with a second amount of aqueous sodium hydroxide and continuously or incrementally contacting the cellulose ether of second level of alkalization with a second amount of a methylating agent. In the first stage the weight ratio NaOH/cellulose is 0.42/1.0 to 0.55/1.0 and the weight ratio of the methylating agent methyl chloride/cellulose is 0.60/1.0 to 0.74/1.0, which corresponds to molar ratios of 1.7 to 2.2 mol alkali hydroxide and 1.9 to 2.4 mol methyl chloride per mol of anhydroglucose units in the cellulose. In the second stage the weight ratio NaOH/cellulose is 0.4/1.00 to 1.0/1.0 and the weight ratio of the methylating agent methyl chloride/cellulose is 0.61/1.0 to 1.3/1.0, which corresponds to molar ratios of 1.6 to 4.1 mol alkali hydroxide and 2.0 to 4.2 mol methyl chloride per mol of anhydroglucose units in the cellulose.

International Patent Applications WO 2013/059064 and WO 2013/059065 relate to compositions for inducing satiety which comprise methylcellulose that gels in the stomach. The methylcellulose is produced in two stages, similar to the procedure in U.S. Pat. No. 6,235,893. In the first stage, a 50 weight percent aqueous solution of sodium hydroxide is contacted with cellulose at amounts of 1.8 mol of sodium hydroxide and 2.3 mol of methyl chloride per mol of anhydroglucose units of the cellulose. In the second stage 3.4 mol of methyl chloride per mol of anhydroglucose units and a 50 weight percent aqueous solution of sodium hydroxide at an amount of 2.9 mol of sodium hydroxide per mol of anhydroglucose units are added.

Methylcelluloses which are produced in a process wherein alkalization is conducted in two stages and that are, e.g., disclosed in WO 2013/059064, in WO 2013/059065 or in U.S. Pat. No. 6,235,893, have a considerably lower gelation temperature than standard methylcelluloses which are produced in a process wherein the alkalization is conducted in a single stage.

In hydroxyalkyl methylcelluloses the degree of the methyl substitution, DS(methyl), in the art also designated as degree of the methoxyl substitution, DS(methoxyl), which is the average number of OH groups substituted with methoxyl groups per anhydroglucose unit, is also an essential property. Hydroxyalkyl methylcelluloses of a high DS(methyl) often have a reduced content of water-insoluble fibers. Water-insoluble fibers are undesirable in many end-uses, e.g., they lead to defects in coating or capsules produced from or comprising hydroxyalkyl methylcelluloses. Moreover, water-insoluble fibers often cause difficulties in processing steps, such as blocking of filters in purification steps. Hydroxyalkyl methylcelluloses are also defined by the degree of the substitution of hydroxyl groups of the anhydroglucose units by hydroxyalkoxyl groups, which is expressed by the molar substitution of hydroxyalkoxyl groups, the MS(hydroxyalkoxyl). The MS(hydroxyalkoxyl) is the average number of mols of hydroxyalkoxyl groups per anhydroglucose unit in the cellulose ether.

International Patent Applications WO 2012/051035; WO 2012/051034; and WO 2012/173838 disclose hydroxyalkyl methyl celluloses which have a decreased gelation temperature and their uses in capsules, in coatings for pharmaceutical dosage forms, in extrusion-molded bodies and in food compositions. These hydroxyalkyl methyl celluloses are produced in a process wherein cellulose pulp or, as the reaction of cellulose pulp to the hydroxyalkyl methyl cellulose proceeds, partially reacted cellulose pulp, is alkalized in two stages with an aqueous alkaline solution of an alkali metal hydroxide, such as sodium hydroxide. The aqueous alkaline solution in both stages has an alkali metal hydroxide content of from 30 to 70 percent, most preferably from 48 to 52 percent, based on the total weight of the aqueous alkaline solution. From 1.2 to 2.0 molar equivalents of alkali metal hydroxide per mol of anhydroglucose units in the cellulose are added in the first stage. A methylating agent, such as methyl chloride, is also added to the cellulose pulp, typically after the addition of the alkali metal hydroxide. If the methylating agent is added in a single stage, it is added in an amount of from 3.5 to 5.3 mols of methylating agent per mol of anhydroglucose units. If the methylating agent is added in two stages, in the first stage it is added in an amount of from 2 to 2.5 mols of methylating agent per mol of anhydroglucose units and in the second stage it is added in an amount of from 1.5 to 3.4 mols per mol of anhydroglucose units. From 1.0 to 2.9 molar equivalents of alkali metal hydroxide per mol of anhydroglucose units are added in the second stage.

In view of the wide variety of end-uses of methylcelluloses and hydroxyalkyl methyl celluloses having a decreased gelation temperature, it would be desirable to find a process to produce the methylcelluloses and/or hydroxyalkyl methyl celluloses in a more efficient way and/or to find a process for producing methylcelluloses and/or hydroxyalkyl methyl celluloses having an increased DS(methoxyl).

### SUMMARY

Surprisingly, it has been found that methylcelluloses and/or hydroxyalkyl methyl celluloses can be produced in a more efficient way and/or an increased DS(methoxyl) is achieved when alkalization is conducted in two stages and the second alkalization stage is conducted with solid alkali hydroxide.

Accordingly, the present invention relates to a process for producing a methylcellulose or a hydroxyalkyl methylcellulose which comprises the steps of a) contacting cellulose with an aqueous alkali hydroxide to produce alkali cellulose; b) reacting the alkali cellulose produced in step a) with a methylating agent in the presence or absence of a hydroxyalkylating agent to obtain a first reaction mixture; c) contacting the first reaction mixture obtained in step b) with solid alkali hydroxide having a water content of not more than 20 wt. %, based on dried alkali hydroxide, with or without contacting a second amount of a methylating agent with the first reaction mixture, to obtain a second reaction mixture; and d) isolating the produced methylcellulose or hydroxyalkyl methylcellulose from the second reaction mixture.

### DESCRIPTION OF EMBODIMENTS

In step a) of the process of the present invention cellulose is contacted with an aqueous alkali hydroxide to produce alkali cellulose. The cellulose is preferably in pulp form; examples are cotton linters and wood pulp, e.g. hard wood or soft wood pulp. The pulp is preferably provided in a powder or chip form. Wood pulp is preferred. More preferably, wood pulp in powder form is utilized.

In step a) of the process the cellulose may be alkalized with aqueous alkali hydroxide by any means known in the art, such as steeping in a bath or stirred tank containing aqueous alkali hydroxide or spraying aqueous alkali hydroxide directly on dry cellulose, preferably pulp. Uniform swelling and alkali distribution in the cellulose is preferably controlled by mixing and agitation. The aqueous alkali hydroxide preferably has an alkali hydroxide concentration of from 40 to 70 weight percent, more preferably from 45 to 60 weight percent, and most preferably from weight 48 to 52 percent, based on the total weight of the aqueous alkali hydroxide, i.e., based on the total weight of alkali hydroxide and water. The alkali hydroxide preferably is potassium hydroxide or, more preferably, sodium hydroxide. In step a) cellulose is generally contacted with 1.0 to 3.0 mol alkali hydroxide, preferably with 1.1 to 2.5 mol alkali hydroxide, more preferably with 1.2 to 2.0 mol alkali hydroxide, even more preferably with 1.2. to 1.7 mol alkali hydroxide, and most preferably with 1.3 to 1.6 mol alkali hydroxide per mol of anhydroglucose units in the cellulose. In step a) of the process the rate of addition of the aqueous alkali hydroxide is not very critical. It can be added in several portions, e.g., in 2 to 4 portions, or continuously. The rate of addition of aqueous alkali hydroxide is generally governed by the ability to cool the reactor during the exothermic alkalization reaction. In one embodiment, an organic solvent such as dimethyl ether is added to the reactor as a diluent and a coolant. Likewise, the headspace of the reactor is optionally purged with an inert gas (such as nitrogen) to minimize unwanted reactions with oxygen and molecular weight losses of the methylcellulose or hydroxyalkyl methylcellulose. In one embodiment, the temperature is maintained at or below 45° C. Reaction time varies according to alkali hydroxide concentration and temperature. The alkalization in step a) of the process typically lasts from 10 to 60 minutes.

In step b) of the process of the present invention the alkali cellulose that has been produced in step a) above is reacted with a methylating agent in the presence or absence of a hydroxyalkylating agent to obtain a first reaction mixture. Preferred methylating agents are methyl chloride or dimethyl sulfate. Methyl chloride is preferred. The methylating agent may be added in a batch load at one time or continuously or incrementally over a period of time. “Batch load addition” means addition substantially without pause over a relatively short period of time. “Continuous addition” means addition substantially without pause over a longer period of time. “Incremental addition” means periodic addition of smaller, discrete amounts over a longer period of time. The methylating agent can be added to the cellulose before, after, or concurrently with the addition of aqueous alkali hydroxide in step a). Preferably, the methylating agent is added after addition of the aqueous alkali hydroxide to cellulose. In any event, the methylation reaction in step b) only takes place after cellulose has been reacted to alkali cellulose in step a).

In the process of the present invention, the total amount of the methylating agent is generally from 2 to 9.0 mols per mol of anhydroglucose units. The methylating agent can be added to the cellulose, to alkali cellulose, or, as the reaction of cellulose to the methylcellulose or hydroxyalkyl methylcellulose proceeds, to partially reacted cellulose, in a single stage. If the methylating agent is added in a single stage, the entire amount of methylating agent is added in step b) of the process of the present invention. In this case the methylating agent is generally added in an amount of from 2 to 9.0 mols of methylating agent per mol of anhydroglucose units, but in any event, it is added in at least an equimolar amount, compared to the added total molar amount of alkali metal hydroxide, before heating the reaction mixture.

Preferably, the methylating agent is added in two stages, i.e., preferably a first amount is reacted in step b) of the process of the present invention and a second amount is added in step c) of the process of the present invention. If the methylating agent is added in two stages, in step b) generally from 0.4 to 3.5 mol, preferably from 0.5 to 3.0 mol, more preferably from 0.5 to 2.5 mol, even more preferably from 0.5 to 2.2 mol, and most preferably from 0.5 to 2.1 mol of methylating agent is added per mol of anhydroglucose units in the cellulose. If the methylating agent is added in two stages, the methylating agent of the first stage is preferably added at a rate of from, 0.25 to 0.5 molar equivalents of methylating agent per mol of anhydroglucose units per minute.

The methylating agent may be pre-mixed in step b) with a suspending agent. In this case the mixture of suspending agent and methylating agent preferably comprises from 20 to 80 weight percent, more preferably from 30 to 75 weight percent, of the suspending agent, based on the total weight of methylating agent and suspending agent.

The reaction of the alkali cellulose produced in step a) with the methylation agent can be conducted in the absence or presence of a hydroxyalkylating agent, such as ethylene oxide and/or propylene oxide. For producing methylcellulose, the reaction of the alkali cellulose is conducted with the methylation agent in the absence of a hydroxyalkylating agent.

For producing a hydroxyalkyl methylcellulose, the reaction of the alkali cellulose with the methylation agent is conducted in the presence of a hydroxyalkylating agent, preferably one or two types of hydroxyalkylating agents, such as ethylene oxide and/or propylene oxide, more preferably only one type of hydroxyalkylating agent. The most preferred hydroxyalkylating agent is propylene oxide. The hydroxyalkylating agent(s) is/are added to the cellulose, to alkali cellulose, or, as the reaction of cellulose to the hydroxyalkyl methylcellulose proceeds, to partially reacted cellulose, either before, after, or concurrently with the alkali hydroxide added in step a). Preferably, the hydroxyalkylating agent is added after addition of the aqueous alkali hydroxide to cellulose. In any event, the hydroxyalkylating reaction in step b) only takes place after cellulose has been reacted to alkali cellulose in step a). The hydroxyalkylating agent is generally added in an amount of 0.2 to 7.0 mol, preferably from 0.5 to 6.5 mol of hydroxyalkylating agent per mol of anhydroglucose units. The hydroxyalkylating agent is advantageously added before heating the reaction mixture to the reaction temperature in step b).

Upon addition of the methylating agent and optionally the hydroxyalkylating agent, the reaction temperature is typically increased over a time period of 20 to 80 minutes, more typically of 25 to 60 minutes, to a temperature of from 50° C. to 110° C., more preferably from 60° C. to 100° C. and most preferably from 60° C. to 90° C. The methylation and optional hydroxyalkylation in step b) of the process typically lasts from 30 to 180 minutes. After the methylation and optional hydroxyalkylation reaction in step b), the obtained first reaction mixture may be cooled. Cooling is typically conducted when producing hydroxyalkyl methylcellulose; in this case the first reaction mixture is typically cooled to a temperature of from 60 to 30° C., preferably to a temperature of from 50 to 35° C.

In step c) of the process of the present invention the first reaction mixture obtained in step b) is mixed with solid alkali hydroxide that has a water content of not more than 20 weight percent (wt. %), based on dried alkali hydroxide, to obtain a second reaction mixture, with or without contacting a second amount of a methylating agent with the first reaction mixture. It is essential that in step c) solid alkali hydroxide is utilized that has a water content of not more than 20 wt. %, preferably not more than 15 wt. %, more preferably not more than 10 wt. %, and most preferably not more than 5 wt. %, based on dried alkali hydroxide. In the most preferred embodiment dried alkali hydroxide is used. The shape of the solid alkali hydroxide is not critical in the present invention, for example the solid alkali hydroxide can be utilized in the shape of microprills, granules, flakes, plates, or powder.

It has surprisingly been found that (hydroxyalkyl) methylcellulose of a higher DS(methoxyl) is produced when in step c) solid alkali hydroxide is utilized instead of aqueous alkali hydroxide, even when all other process conditions are kept the same. Hence, (hydroxyalkyl) methylcelluloses can be produced in a more efficient manner. (Hydroxyalkyl) Methylcelluloses having an increased DS(methoxyl) can be produced when utilizing in step c) solid alkali hydroxide instead of aqueous alkali hydroxide, even when the amount of methylating agent is not increased. Alternatively, in the process of the present invention (hydroxyalkyl) methylcelluloses can be produced that have the same DS(methoxyl) as (hydroxyalkyl) methylcelluloses produced by a known process wherein aqueous alkali hydroxide is utilized in the second alkalization step, even when a reduced amount of methylating agent is used in the process of the present invention as compared to a known process. The term “(hydroxyalkyl) methylcellulose” stands for methylcellulose or hydroxyalkyl methylcellulose or both. In step c) of the process the first reaction mixture obtained in step b) is generally mixed with 1.2 to 7 mol, preferably with 1.3 to 6.7 mol, and more preferably with 1.4 to 6.5 mol, of solid alkali hydroxide per mol of anhydroglucose units in the cellulose. When methylcellulose is produced, the first reaction mixture obtained in step b) is generally mixed with 1.2 to 3.5 mol, preferably with 1.3 to 3 mol, more preferably with 1.4 to 2.8 mol, even more preferably with 1.5 to 2.7 mol, and most preferably with 1.7 to 2.6 mol of solid alkali hydroxide per mol of anhydroglucose units in the cellulose. The solid alkali hydroxide may be added in step c) in a batch load at one time or continuously or incrementally over a period of time. In a preferred embodiment, the solid alkali hydroxide is added to the reaction mixture while maintaining a temperature at 20 to 70° C., preferably from 30 to 60° C., most preferably 35 to 50° C.

In step c) of the process of the present invention a second amount of methylating agent is optionally added to the first reaction mixture obtained in step b), in addition to the previously added methylating agent. If a second amount of methylating agent is added to the first reaction mixture obtained in step b), the second amount of methylating agent can be added before, after, or concurrently with the solid alkali hydroxide. Preferably, the second amount of methylating agent is added prior to the solid alkali hydroxide. In step c) of the process, the first reaction mixture obtained in step b) is generally mixed with 1.5 to 8.5 mol, preferably with 1.8 to 8.2 mol, more preferably with 2.0 to 8.0 mol, and most preferably with 2.2 to 7.5 mol methylating agent per mol of anhydroglucose units in the cellulose. When methylcellulose is produced, the first reaction mixture obtained in step b) is generally mixed with 1.5 to 4.5 mol, preferably with 1.8 to 4.0 mol, more preferably with 2.0 to 3.2 mol, and most preferably with 2.2 to 2.8 mol of methylating agent per mol of anhydroglucose units in the cellulose.

In one embodiment of step c) of the invention the methylating agent may be added in a batch load, continuously or incrementally over a period of time. The methylating agent is typically added at a temperature of from 30° C. to 90° C.; preferably at 35° C. to 85° C.; and most preferably at 40° C. to 80° C. Preferably the methylating agent added in step c), if any, is added in such amount that the total molar amount of methylating agent added in one or two steps is at least equimolar to the total amount of sodium hydroxide added in steps a) and c).

Upon addition of the solid alkali hydroxide and optionally the methylating agent in step c), the reaction temperature is typically increased over a time period of 20 to 120 minutes, more typically of 25 to 100 minutes, to a temperature of from 50° C. to 110° C., more preferably from 60° C. to 100° C. and most preferably from 60° C. to 90° C. Regardless whether an additional amount of methylating agent is added in step c) or not, at the reaction temperature an additional alkalization and methylation takes place which typically lasts from 10 to 120 minutes.

In step d) of the process of the present invention the produced methylcellulose or hydroxyalkyl methylcellulose is isolated from the second reaction mixture that has been produced in step c). Typically, the methylcellulose or hydroxyalkyl methylcellulose is washed to remove salt and other reaction by-products. Any solvent in which salt is soluble may be employed, but water is preferred. The methylcellulose or hydroxyalkyl methylcellulose may be washed in the reactor but is preferably washed in a separate washer located downstream of the reactor. Before or after washing, the methylcellulose or hydroxyalkyl methylcellulose may be stripped by exposure to steam to reduce residual organic content. According to the process of the present invention methylcellulose or hydroxyalkyl methylcellulose is obtained which generally has a viscosity of more than 200 mPa·s, preferably from 500 to 300,000 mPa·s, more preferably from 500 to 200,000 mPa·s, most preferably from 1,000 to 150,000 mPa·s, and particularly from 1,000 to 100,000 mPa·s, determined in a 2% by weight aqueous solution at 20° C. at a shear rate=2.51 s⁻¹.

The methylcellulose or hydroxyalkyl methylcellulose may subsequently be subjected to a partial depolymerization process. Partial depolymerization processes are well known in the art and described, for example, in European Patent Applications EP 1,141,029; EP 210,917; EP 1,423,433; and US Pat. No. 4,316,982. Alternatively, partial depolymerization can be achieved during the production of the methylcellulose or hydroxyalkyl methylcellulose, for example by the presence of oxygen or an oxidizing agent. In such partial depolymerization process methylcellulose or hydroxyalkyl methylcellulose is typically obtained which has a viscosity of from 2 to 200 mPas, preferably from 2 to 100 mPa·s, more preferably from 2.5 to 50 mPas, in particular from 3 to 30 mPa·s, determined in a 2% by weight aqueous solution at 20° C.

The viscosity of methylcellulose and hydroxyalkyl methylcellulose is determined as a 2 weight-% solution in water at 20° C. To achieve a homogenous solution, 4 g of the (hydroxyalkyl) methylcellulose powder (under consideration of the water content of the (hydroxyalkyl) methylcellulose) is added to 196 g water at room temperature and stirred with an overhead laboratory stirrer at 500-1000 rpm for at least 60 min. Optionally the solution is further cooled with ice to achieve complete dissolution, particularly in the case of methylcellulose. The solution is further stored at room temperature or in a refrigerator over night.

The viscosity of hydroxyalkyl methylcellulose, preferably hydroxypropyl methylcellulose, is determined in a 2% by weight aqueous solution at 20° C. in a Anton Paar MCR 501 with cup and bob geometry (CC-27) at 20° C. and at a shear rate of 2.51 s-1.

The viscosity of methylcellulose is determined in a 2% by weight aqueous solution at 20° C. according to the same procedure as described above for hydroxyalkyl methylcellulose above but with cooling of the solution after the addition of the methylcellulose to the water with ice for 1 h.

The methylcellulose or hydroxyalkyl methylcellulose is dried to a reduced moisture and volatile content of preferably 0.5 to 10.0 weight percent water and volatile content and more preferably 0.8 to 5.0 weight percent water and volatile content, based upon the weight of methylcellulose or hydroxyalkyl methylcellulose. The reduced moisture and volatiles content enables the methylcellulose or hydroxyalkyl methylcellulose to be milled into particulate form. The methylcellulose or hydroxyalkyl methylcellulose is milled to particulates of desired size. If desired, drying and milling may be carried out simultaneously.

In one embodiment of the process of the present invention methylcellulose is produced. The methylcellulose preferably has a viscosity as indicated above. Furthermore, the produced methylcellulose preferably has a methoxyl substitution of from 21 to 42 weight percent, more preferably from 25 to 35 weight percent, and most preferably from 29.5 to 35 weight percent, based upon the weight of the methylcellulose. The determination of the % methoxyl in methylcellulose is carried out according to the United States Pharmacopeia (USP 35). The values obtained are % methoxyl. These are subsequently converted into degree of substitution (DS) for methyl substituents. Residual amounts of salt are taken into account in the conversion.

In another embodiment of the process of the present invention hydroxyalkyl methylcellulose, preferably hydroxypropyl methylcellulose (HPMC), is produced. The hydroxyalkyl methylcellulose, preferably HPMC, preferably has a viscosity as indicated above. Furthermore, the hydroxyalkyl methylcellulose, preferably HPMC, preferably has a methoxyl substitution of from 16 to 35 weight percent, more preferably from 18 to 35 weight percent, and most preferably from 26 to 35 weight percent, and a hydroxyalkoxyl substitution, preferably a hydroxypropoxyl substitution, of preferably from 4 to 35 weight percent, more preferably from 4 to 30 weight percent, and most preferably from 4 to 28 weight percent, based on the weight of the hydroxyalkyl methylcellulose, preferably HPMC.

The determination of the % methoxyl and % hydroxypropoxyl in HPMC is carried out according to the United States Pharmacopeia (USP 35). The values obtained are % methoxyl and % hydroxypropoxyl. These are subsequently converted into degree of substitution for methyl substituents, DS(methoxyl), and molar substitution for hydroxypropyl substituents, MS(hydroxypropoxyl). Residual amounts of salt are taken into account in the conversion.

The determination of the DS(methyl) and MS(hydroxyethyl) in hydroxyethyl methylcellulose is effected by Zeisel cleavage with hydrogen iodide followed by gas chromatography. (G. Bartelmus and R. Ketterer, Z. Anal. Chem. 286 (1977) 161-190).

Some embodiments of the invention will now be described in detail in the following Examples.

### EXAMPLES

Unless otherwise mentioned, all parts and percentages are by weight. In the Examples the following test procedures are used.

### Determination of the Viscosity of Methylcellulose (MC) and Hydroxypropyl Methylcellulose (HPMC)

The viscosity of MC and HPMC is determined as a 2 weight-% solution in water. To achieve a homogenous solution, 4 g of the MC or HPMC powder (under consideration of the water content of the MC or HPMC) is added to 196 g water at room temperature and stirred with an overhead laboratory stirrer at 500-1000 rpm for at least 60 min. Optionally the solution is further cooled with ice to achieve complete dissolution, particularly in the case of MC. The solution is further stored at room temperature or in a refrigerator over night.

The viscosity of hydroxyalkyl methylcellulose, preferably hydroxypropyl methylcellulose, is determined in a 2% by weight aqueous solution at 20° C. in a Anton Paar MCR 501 with cup and bob geometry (CC-27) at 20° C. and at a shear rate of 2.51 s-1.

The viscosity of methylcellulose is determined in a 2% by weight aqueous solution at 20° C. according to the same procedure as described above for hydroxyalkyl methylcellulose above but with cooling of the solution after the addition of the methylcellulose to the water with ice for 1 h.

### Determination of the % Methoxyl in MC

The determination of the % methoxyl in methylcellulose is carried out according to the United States Pharmacopeia (USP 35). The values obtained are % methoxyl. These are subsequently converted into degree of substitution (DS) for methyl substituents. Residual amounts of salt are taken into account in the conversion.

### Determination of the % methoxyl and % hydroxypropoxyl in HPMC

The determination of the % methoxyl and % hydroxypropoxyl in HPMC is carried out according to the United States Pharmacopeia (USP 35).

The values obtained are % methoxyl and % hydroxypropoxyl. These are subsequently converted into degree of substitution for methyl substituents, DS(methoxyl), and molar substitution for hydroxypropyl substituents, MS(hydroxypropoxyl).

Residual amounts of salt are taken into account in the conversion.

Comparative Example A—Production of Methylcellulose Finely ground wood cellulose pulp was sieved through a sieve of 400 μm after grinding and subsequently loaded into a jacketed, agitated reactor. The reactor was evacuated and purged with nitrogen to remove oxygen and then evacuated again.

The reaction was carried out in two stages. In the first stage a 50 weight percent aqueous solution of sodium hydroxide was sprayed onto the cellulose until the level reached 1.5 mol of sodium hydroxide per mol of anhydroglucose units in the cellulose, and then the temperature was adjusted to 40° C. After stirring the mixture of aqueous sodium hydroxide solution and cellulose for 30 minutes at 40° C., 1.5 mol of dimethyl ether and 2.0 mol of methyl chloride per mol of anhydroglucose units were added to the reactor. The contents of the reactor were then heated in 40 min to 80° C. After having reached 80° C., the first stage reaction was allowed to proceed for 40 min.

The second stage of the reaction was started by addition of a 49.7 weight percent aqueous solution of sodium hydroxide at an amount of 2.0 mol of sodium hydroxide per mol of anhydroglucose units. Then methyl chloride at an amount of 2.5 mol of methyl chloride per mol of anhydroglucose units was added. The second stage reaction was allowed to proceed for 90 min. After the reaction the reactor was vented. The contents of the reactor were removed and transferred to a tank containing hot water. The crude methylcellulose was then washed with hot water and dried in an air-swept drier. The material was then ground in a mill with a 0.5 mm screen.

### Examples 1 to 3—Production of Methylcellulose

Comparative Example A was repeated, except that in the second stage of the reaction (step c) of the process of the invention) solid sodium hydroxide was used at an amount of 2.0 mol of sodium hydroxide per mol of anhydroglucose units (AGU). In Example 1 solid NaOH flakes (purity at least 98.0%) were used, in Example 2 solid NaOH pellets (purity at least 98.0%) were used, and in Example 3 solid NaOH microprills (purity at least 98.5%) were used.

The properties of the produced methylcelluloses are listed in Table 1 below.

TABLE 1

| | Comparative | Example | Example | Example |
|---|---|---|---|---|
| | Example A | 1 | 2 | 3 |
| Process steps | | | | |
| Mol NaOH/mol | 2.0 | 2.0 | 2.0 | 2.0 |
| AGU in step c) | | | | |
| of process | | | | |
| Form of NaOH | 49.7 wt. % | solid | solid | solid |
| | aq. | NaOH | NaOH | NaOH |
| | solution | flakes | pellets | microprills |
| Methylcellulose | | | | |
| properties | | | | |
| % methoxyl | 29.1 | 30.8 | 31.0 | 31.3 |
| DS(methoxyl) | 1.75 | 1.87 | 1.88 | 1.91 |
| Viscosity | 7232 | 7207 | 7780 | 7333 |
| (2% in water at | | | | |
| 20° C. (mPa*s) | | | | |

The results in Table 1 above illustrate that methylcellulose of a higher methoxyl substitution, i.e., a higher DS(methoxyl), is produced when in the second stage of the reaction, specifically step c) of the process, solid sodium hydroxide is utilized instead of aqueous sodium hydroxide, even when all other process conditions are kept the same.

### Comparative Example B—Production of HPMC

Hydroxypropyl methylcellulose (HPMC) was produced according to the following procedure. Finely ground wood cellulose pulp was sieved through a sieve of 400 μm after grinding and subsequently loaded into a jacketed, agitated reactor. The same ground wood cellulose pulp was used as in Comparative Example A and in Examples 1-3. The reactor was evacuated and purged with nitrogen to remove oxygen and then evacuated again.

The reaction was carried out in two stages. In the first stage a 50 weight percent aqueous solution of sodium hydroxide was sprayed onto the cellulose in an amount of 1.55 mols of sodium hydroxide per mol of anhydroglucose units in the cellulose and the temperature was adjusted to 40° C. After stirring the mixture of aqueous sodium hydroxide solution and cellulose for 15 minutes at 40° C., 1.7 mols of dimethyl ether, 0.6 mols of methyl chloride and 6.0 mols of propylene oxide per mol of anhydroglucose units were added to the reactor. The contents of the reactor were then heated in 30 min to 65° C. After having reached 65° C., the first stage reaction was allowed to proceed for 75 min. Then the reaction mixture was rapidly cooled down to 40° C. and held there for 15 minutes.

The second stage of the reaction was started by addition of a 49.9 weight percent aqueous solution of sodium hydroxide at an amount of 6.0 mols of sodium hydroxide per mol of anhydroglucose units. Then methyl chloride at an amount of 7.45 molar equivalents of methyl chloride per mol of anhydroglucose units was added. After the second stage addition was completed, the contents of the reactor were heated to a temperature of 85° C. in 90 minutes and then kept at this temperature for 15 min.

After the reaction the reactor was vented and cooled down to ambient temperature. The contents of the reactor were removed and transferred to a tank containing hot water. The crude HPMC was then neutralized with formic acid and washed chloride free with hot water (assessed by AgNO₃ flocculation test), cooled to room temperature and dried at 55° C. in an air-swept drier. The material was then ground using an Alpine UPZ mill using a 0.5 mm screen.

### Examples 4 and 5—Production of HPMC

Comparative Example B was repeated, except that in the second stage of the reaction (step c) of the process of the invention) solid sodium hydroxide was added at an amount of 6.0 mol of sodium hydroxide per mol of anhydroglucose units (AGU) in three portions over 5 mins. In Example 4 solid NaOH pellets (purity 100%) were used, and in Example 5 solid microprills (purity at least 98.5%) were used.

The properties of the produced HPMC are listed in Table 2 below.

TABLE 2

| | Comparative | | |
|---|---|---|---|
| | Example B | Example 4 | Example 5 |
| Process steps | | | |
| Mol NaOH/mol AGU in | 6.0 | 6.0 | 6.0 |
| step c) of process | | | |
| Form of NaOH | 49.9 wt. % | solid | solid |
| | aqueous | NaOH | microprills |
| | solution | pellets | |
| HPMC properties | | | |
| % methoxyl | 27.1 | 30.0 | 33.1 |
| DS(methoxyl) | 2.1 | 2.29 | 2.54 |
| % hydroxypropoxyl | 26.1 | 23.2 | 21.9 |
| MS(hydroxypropoxyl) | 0.83 | 0.73 | 0.69 |
| Viscosity | 3286 | 2733 | 1666 |
| (2% in water at | | | |
| 20° C. (mPa*s) | | | |

The results in Table 2 above illustrate that HPMC of a higher methoxyl substitution, i.e., a higher DS(methoxyl), is produced when in the second stage of the reaction, specifically step c) of the process, solid sodium hydroxide is utilized instead of aqueous sodium hydroxide, even when all other process conditions are kept the same.

1. A process for producing a methylcellulose or hydroxyalkyl methylcellulose comprising the steps of
a) contacting cellulose with an aqueous alkali hydroxide to produce alkali cellulose;
b) reacting the alkali cellulose produced in step a) with a methylating agent in the presence or absence of a hydroxyalkylating agent to obtain a first reaction mixture;
c) contacting the first reaction mixture obtained in step b) with solid alkali hydroxide having a water content of not more than 20 wt. %, based on dried alkali hydroxide, with or without contacting a second amount of a methylating agent with the first reaction mixture, to obtain a second reaction mixture; and
d) isolating the produced methylcellulose or hydroxyalkyl methylcellulose from the second reaction mixture.

2. The process of claim 1 wherein in step c) the solid alkali hydroxide has a water content of not more than 10 wt. %, based on dried sodium hydroxide.

3. The process of claim 1 wherein the aqueous alkali hydroxide in step a) has an alkali hydroxide concentration of from 40 to 70 weight percent, based on the total weight of the aqueous alkali hydroxide.

4. The process of claim 1 wherein in step a) cellulose is contacted with 1.0 to 3.0 mol alkali hydroxide per mol of anhydroglucose units in the cellulose.

5. The process of claim 1 wherein in step a) cellulose is contacted with 1.2 to 1.7 mol alkali hydroxide per mol of anhydroglucose units in the cellulose.

6. The process of claim 1 wherein in step b) from 0.4 to 3.5 mol of methylating agent is added per mol of anhydroglucose units in the cellulose.

7. The process of claim 1 wherein in step b) from 0.5 to 2.2 mol of methylating agent is added per mol of anhydroglucose units in the cellulose.

8. The process of claim 1 wherein in step b) alkali cellulose is reacted with a methylating agent in the presence of from 0.2 to 7.0 mol of a hydroxyalkylating agent per mol of anhydroglucose units in the cellulose.

9. The process of claim 1 wherein in step c) the first reaction mixture obtained in step b) is mixed with 1.2 to 7 mol of solid alkali hydroxide per mol of anhydroglucose units in the cellulose.

10. The process of claim 1 wherein methylcellulose is produced and in step c) the first reaction mixture obtained in step b) is mixed with 1.2 to 3.5 mol of solid alkali hydroxide per mol of anhydroglucose units in the cellulose.

11. The process of claim 1 wherein in step c) the first reaction mixture obtained in step b) is mixed with 1.5 to 4.5 mol methylating agent per mol of anhydroglucose units in the cellulose.

12. The process of claim 1 wherein in step c) the first reaction mixture obtained in step b) is mixed with 2.0 to 3.2 mol methylating agent per mol of anhydroglucose units in the cellulose.

13. The process of claim 1 wherein methylcellulose having a methoxyl substitution of from 26 to 35 weight percent is produced.

14. The process of claim 1 wherein hydroxypropyl methylcellulose having a methoxyl substitution of from 18 to 35 weight percent and a hydroxypropoxyl substitution of from 4 to 30 weight percent is produced.

15. The process of claim 14 wherein hydroxypropyl methylcellulose having a methoxyl substitution of from 26 to 35 weight percent and a hydroxypropoxyl substitution of from 4 to 28 weight percent is produced.
